(19) United States
(12) Patent Application Publication
(10) Pub. No.: US 2005/0236559 A1
(43) Pub. Date: Oct. 27, 2005

(54) Fiber grating strain sensors for civil structures

(76) Inventors: Sean Geoffrey Calvert, Trout Dale, OR (US); Jason Mooney, Newberg, OR (US); Eric Udd, Fairview, OR (US)

Correspondence Address: Eric Udd;Blue Road Research, 376 NE 219th Avenue, Gresham, OR, 97030, US

(21) Appl. No.: 11/078,896

(22) Filed: Mar. 11, 2005

Related U.S. Application Data
(60) Provisional application No. 60/552,846, filed on Mar. 12, 2004.

(51) Int. Cl. G01J 1/42

(52) U.S. Cl. 250/227.14

(57) ABSTRACT

A fiber grating strain sensor package that is optimized for axial strain sensitivity and usage on a civil structure that may be a bridge or building is described in this invention. Transverse strain effects are minimized and axial strain sensitivity is enhanced through the design of a substrate with an optimized geometry. These sensors have been deployed and tested on a bridge demonstrating very high sensitivity and the ability of this design to be packaged in an environmentally rugged housing necessary for a commercially successful product.

This application claims the benefit of U.S. Provisional Application No. 60/552846 by Eric Udd, Sean Calvert, Michele Winz, Jason Mooney and Nicholas Ortyl, “Fiber Optic Grating Systems”, filed Mar. 12, 2004.

This invention was made with Government support from NSF Grant Number DMI-0131967. The government has certain rights to this invention.

### BACKGROUND OF THE INVENTION

This invention discloses means to package a fiber grating strain sensor so that it has high sensitivity and is compatible with the rugged environmental conditions associated with civil structures.

This invention relates generally to fiber optic grating systems and more particularly, to the measurement of strain fields using fiber optic grating sensors and their interpretation. Typical fiber optic grating sensor systems are described in detail in U.S. Pat. Nos. 5,380,995, 5,402,231, 5,592,965, 5,841,131 and 6,144,026.

The need for low cost, a high performance fiber optic grating environmental sensor system that is capable of long term environmental monitoring, virtually immune to electromagnetic interference and passive is critical for many applications. The ideal system to service civil structure applications should have the capability of providing accurate measurements of strain at multiple locations along a single fiber line with high accuracy and stability under severe environmental conditions.

### BRIEF DESCRIPTION OF THE PRESENT INVENTION

In the present invention a fiber grating strain sensor is positioned near the center of a bar of material that is manufactured so that bending is minimized and the effects of axial strain are maximized. The bar is then encased in an enclosure designed to protect the bar from external environmental effects associated with civil structure applications. The bar may be formed by using composite material or by using an appropriately machined metal structure that is designed to maximize axial sensitivity.

Therefore it is an object of the invention to provide a strain sensor optimized to sense axial strain and minimizing bending effects.

Another object of the invention is to provide an environmentally rugged sensor package suitable for usage in civil structures.

### BRIEF DESCRIPTION OF THE DRAWINGS

FIG. 1 is a diagram of a fiber grating strain sensor placed into composite tow material parallel to the fiber strength members associated with the composite material.

FIG. 2 is a photo of a composite beam with a fiber grating strain sensor embedded near the center of the composite beam parallel to the fiber strength members of the composite beam with holes for mounting.

FIG. 3 is a photo of a composite beam with an embedded fiber grating strain sensor attached to a steel I-beam for strain measurements.

FIG. 4 is a photo of an I-beam with 5 composite beams with embedded fiber grating strain sensors attached to a steel I-beam for measuring distributions under loading and impact.

FIG. 5 is a graphical illustration of the response of one of the composite beam fiber grating strain sensors shown in FIG. 4 to an impact.

FIG. 6 is an illustration of mechanical elements of the housing used to protect the composite fiber grating strain sensor for deployment on a bridge.

FIG. 7 is a photo of a composite beam with an embedded fiber grating strain sensor near its center mounted in a mechanical housing that is used to test for strain sensitivity. The center region of the composite beam has been decreased in area to improve axial strain response.

FIG. 8 is a photo of a fiber grating strain sensor that has been mounted across a cut out in a metal bar that forms a diamond pattern designed to maximize axial sensitivity.

FIG. 9 is a photo of a metal bar with the center portion cut out to form a diamond shape for optimum axial sensitivity and a fiber grating strain sensor mounted across it.

FIG. 10 is a photo of fiber grating strain sensor mounted across a metal bar with a diamond shaped cut out and elements of a housing used to enable long term performance in a severe environment.

FIG. 11 is a photo of the final assembly of the sensor shown in FIG. 10.

FIG. 12 is an illustration of other patterns that may be implemented on a metal bar to enable increased axial sensitivity.

FIG. 13 is an illustration of four fiber grating strain sensors that could be placed to measure multiple dimensions of strain as well as shear strain.

### DETAILED DESCRIPTION OF THE SHOWN EMBODIMENTS

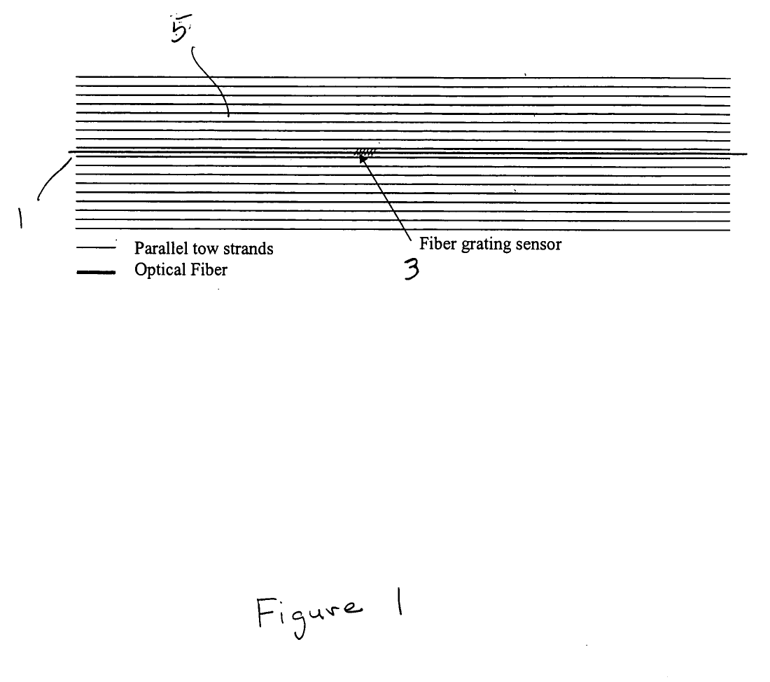

In FIG. 1 an optical fiber 1 containing a fiber grating strain sensor 3 is embedded into a layer of composite material 5 which has its fiber strength elements aligned parallel to the optical fiber 1. In general the fiber strength members associated with the composite material are short on the order of a cm or less and have diameters that are usually less than 10 microns. The optical fiber 1 which is designed to carry a single mode optical light beam has a diameter that generally exceeds 30 microns and may be at standard diameters of 70 or 125 microns which are commonly used in association with fiber optic sensors and telecommunications respectively. The optical fiber 1 is oriented parallel to the fiber strength members in the composite material 5 in order to maximize axial sensitivity and minimize bend sensitivity.

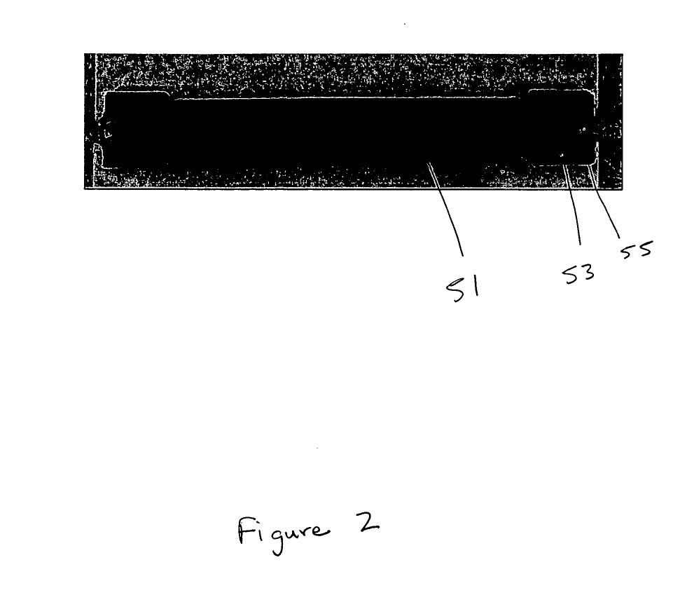

FIG. 2 is a photo of a composite beam fiber grating strain sensor 51 that is comprised of several layers of composite material with their strength members oriented primarily along the longitudinal axis of the beam to maximize sensitivity in that direction. The fiber grating strain sensor has been embedded near the center of the beam to maximize response to axial strain and to minimize response to bending. Mounting holes 53 and 55 have been incorporated into the beam 51 to simplify attachment to steel test beams.

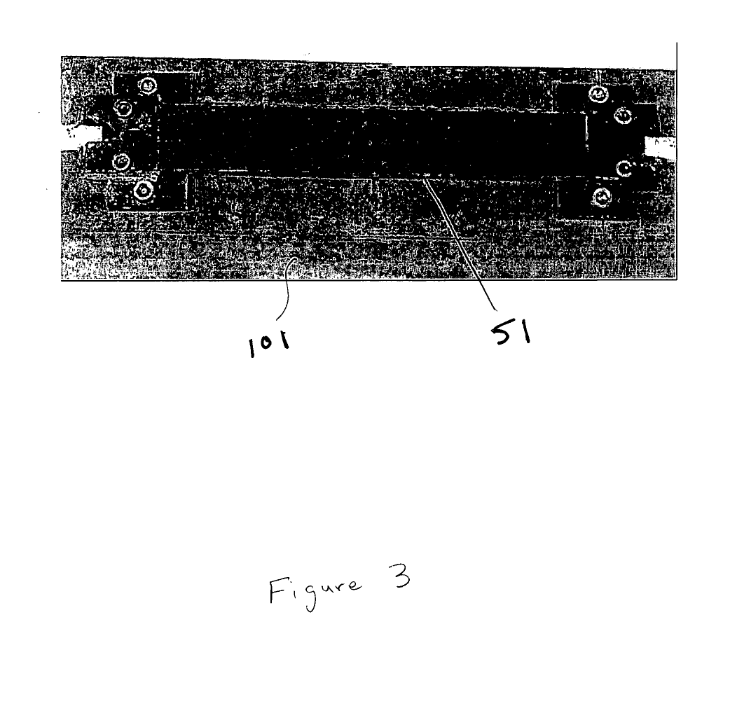

FIG. 3 is a photo of the composite beam fiber grating strain sensor 51 mounted onto a steel beam 101 to demonstrate its ability to detect strain changes.

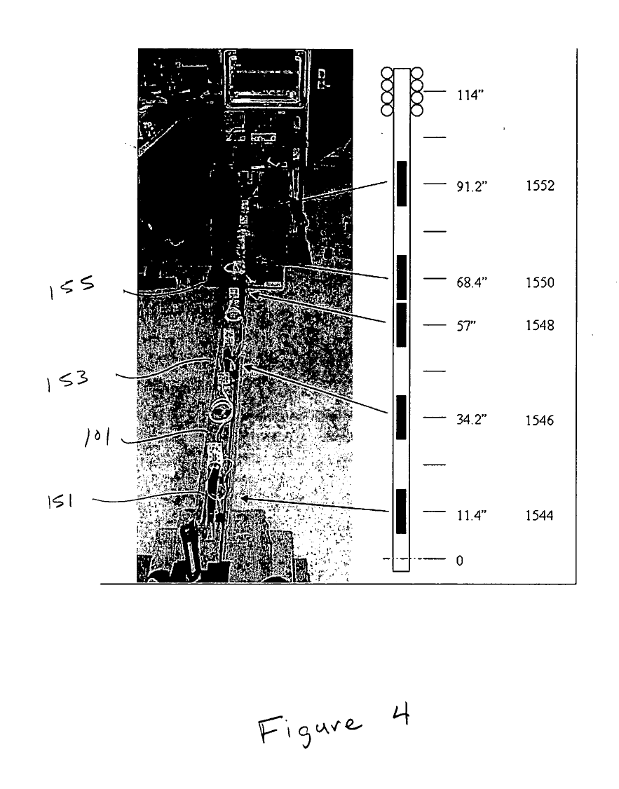

FIG. 4 is a photo of a series of composite beam fiber grating strain sensors 151, 153, and 155 that are mounted to a steel beam 101 that is subject to an impact. The vibrations induced by the impact can in turn be measured by the composite beam strain sensors 151, 153 and 155 and used to perform modal analysis on the beam 101.

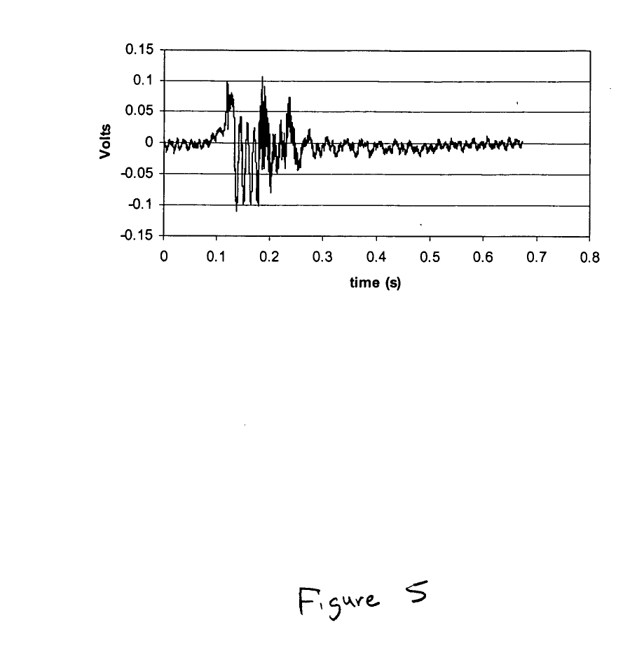

FIG. 5 shows a typical measurement of the vibration signal from one of the composite beam fiber grating strain sensors 151, 153, and 155 after an impact.

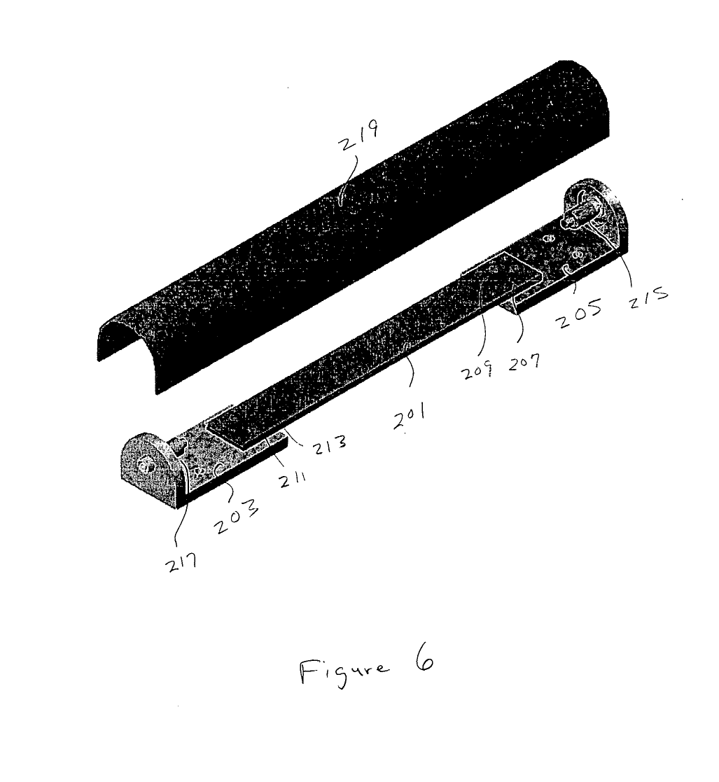

In order to be used in a severe environment such as that associated with a bridge it is necessary to package the composite beam fiber grating strain sensor into a rugged housing. FIG. 6 shows an illustration of the mechanical breakout associated with this type of housing. The composite beam fiber optic strain sensor 201 is attached at each end to angled mounting brackets 203 and 205 via the mounting holes 207 and 209. Fiber optic feed throughs 215 and 217 are used to support fiber optic leads to and from the composite beam fiber grating strain sensor 201. A housing cover 219 is used to enclose the entire assembly.

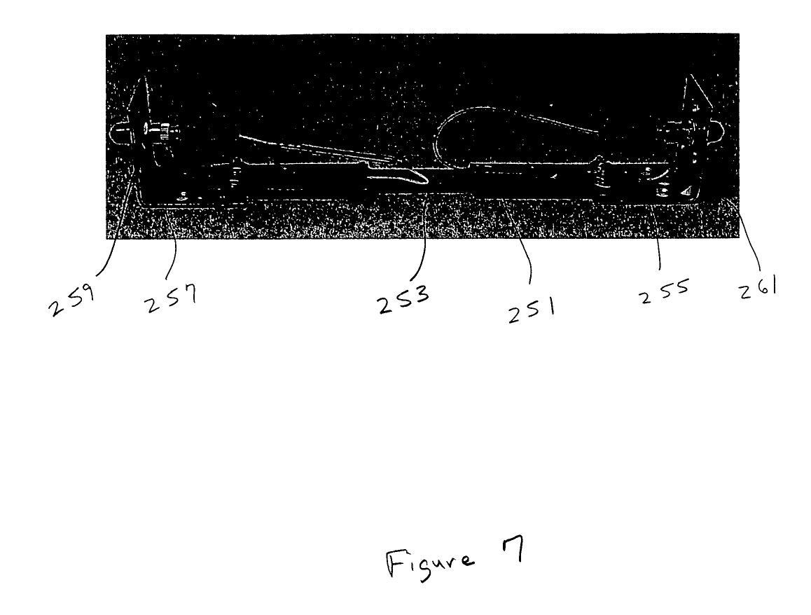

FIG. 7 is a photo of a hardware subassembly that has features that are similar to those shown in association with FIG. 6. A composite beam fiber grating strain sensor 251 has a section 253 that has a narrow cross section to increase axial sensitivity. The composite seam fiber grating strain sensor 251 is connected to the angle brackets 255 and 257 which have fiber optic feed throughs 259 and 261 that are used to support signal processing.

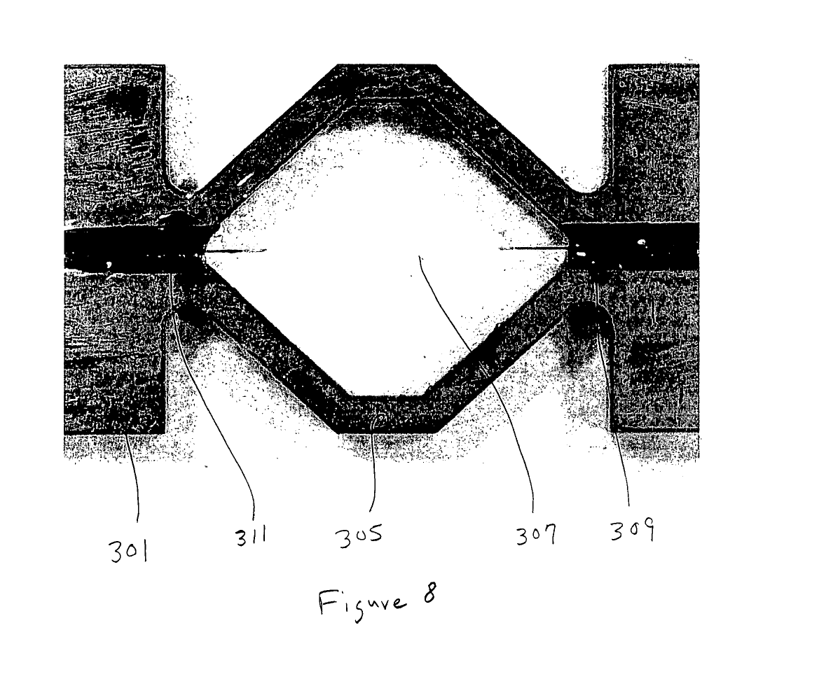

Further enhancements of axial strain sensitivity may be obtained by utilizing structures that have decreased stiffness in the vicinity of the fiber grating sensor. FIG. 8 illustrates a configuration that involves a metal beam 301 that has a central region 305 where significant portions of the metal beam 301 have been removed to improve axial sensitivity while adopting patterns that minimize bending. In the case of the region 305 of the metal beam 301 a diamond shaped pattern has been utilized. A fiber grating strain sensor 307 has been placed under tension and attached at the locations 309 and 311 via adhesive tabs that may be epoxy or a strain gage adhesive. When the metal beam 301 is strained the fiber grating strain sensor 307 is in turn strained allowing accurate measurements to be made.

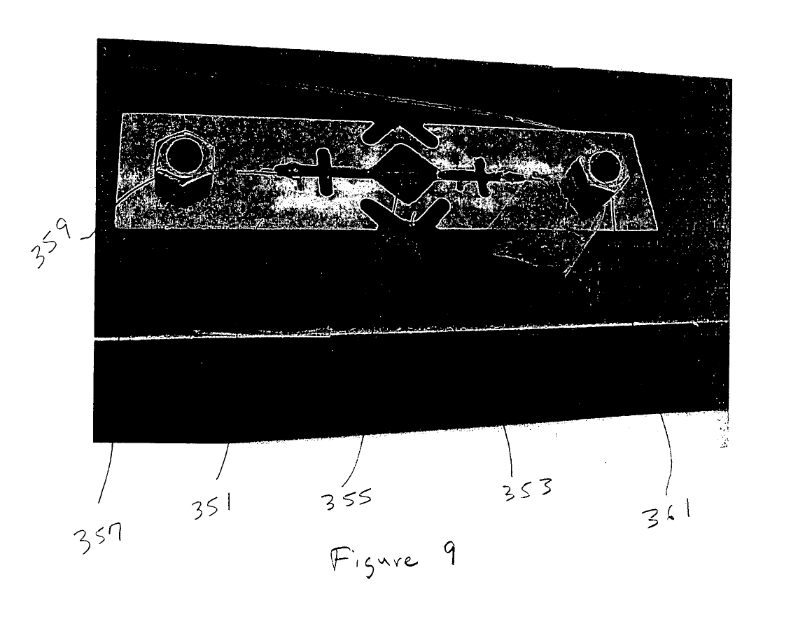

FIG. 9 is a photo of a metal beam fiber grating strain sensor 351 with a diamond region 353 with a fiber grating strain sensor 355 mounted across it under tension. The metal beam fiber grating strain sensor 351 is attached to a steel beam 357 via the bolts 359 and 361.

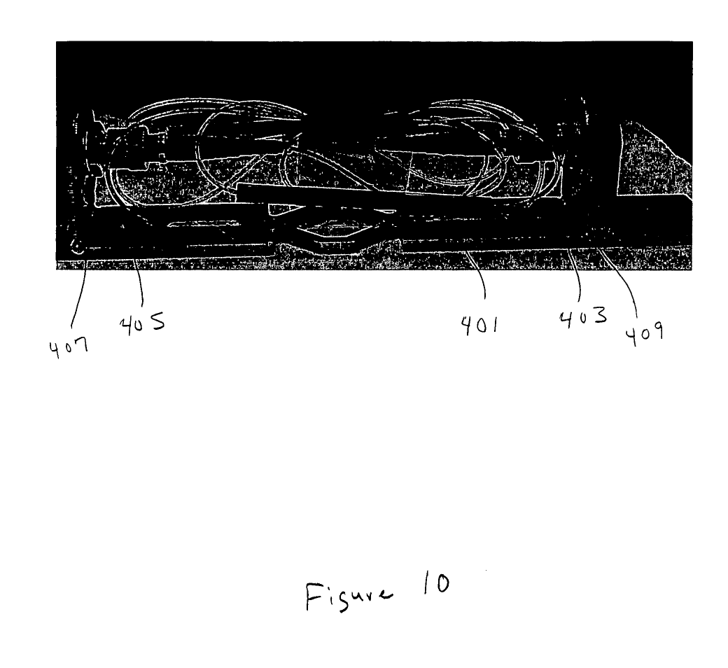

FIG. 10 is a photo of a metal beam fiber grating strain sensor with a diamond shaped cut out mounted on angle brackets 403 and 405 that support fiber optic feed throughs 407 and 409.

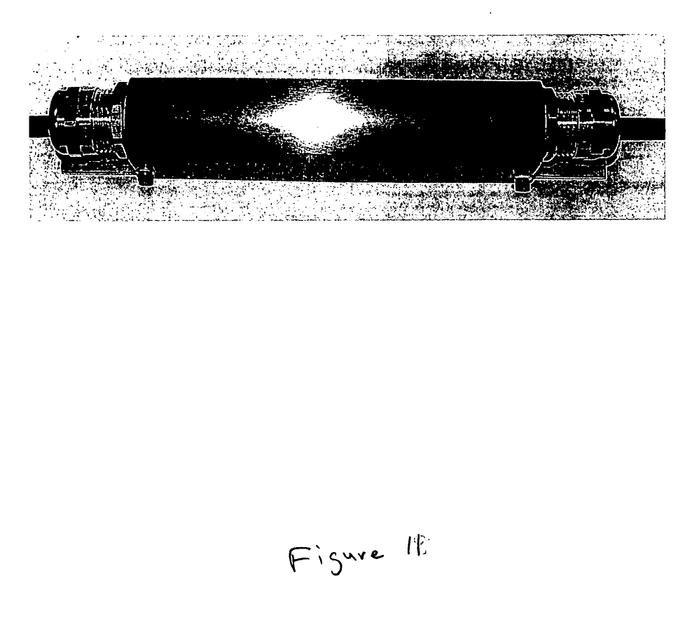

FIG. 11 is a photo of the subassembly associated with FIG. 10 mounted into an environmentally rugged housing similar to that described in association with FIG. 6. This unit and ones similar to it have been used successfully to capture vibration test data on a steel bridge.

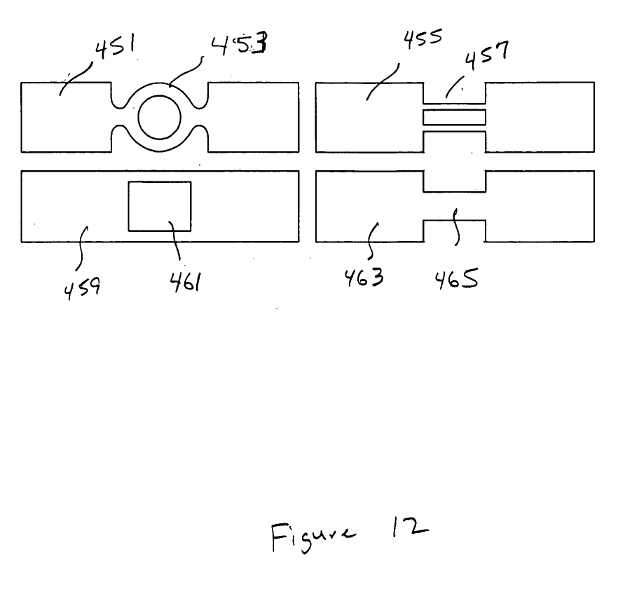

FIG. 12 illustrates a series of metal or composite beam fiber grating strain sensors configured to maximize axial strain sensitivity while minimizing bend sensitivity. The beam 451 has a center section 453 that includes a circular cut out. The beam 455 has a cut out section that 457 that consist of parallel bars. The beam 459 has a rectangular cut out section 461. The beam 463 has a narrower connecting section 465 similar to that illustrated by the photo of FIG. 7. In each of these cases the fiber grating strain sensor can be mounted in tension over the central cut out sections 453, 457, 461 and 465 respectively so that axial strain sensitivity is maximized and bending sensitivity is minimized.

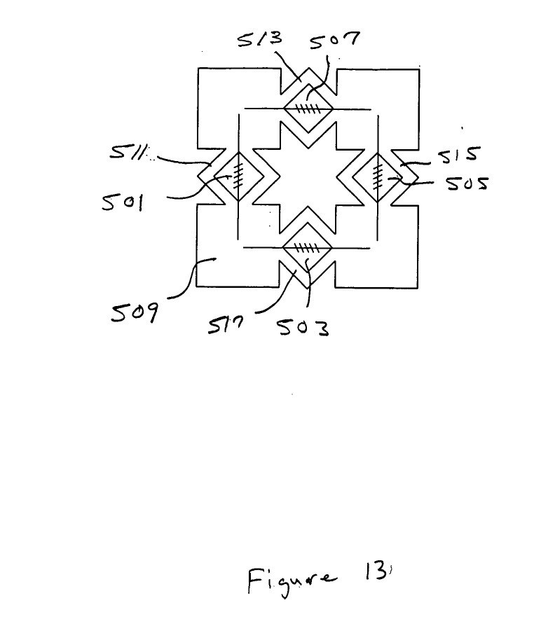

The configurations described above can be extended to cover the case of two dimensional strains. FIG. 13 illustrates an embodiment that consists of four fiber grating strain sensors 501, 503, 505 and 507 that are mounted on a metal or composite plate 509 that contains limited area structures to maximize axial strain that in this case have a diamond structure 511, 513, 515 and 517. When the metal or composite plate 509 is subject to strain in two dimensions the relative measurements made by the fiber grating strain sensors 501, 503, 505 and 507 may be used to determine the strain field. In particular this configuration may be used to measure shear strain by taking the difference in the measurement of strain between parallel fiber grating strain sensors as well as net axial strain by averaging the measurement of strain of the parallel fiber grating strain sensors.

Thus there has been shown and described novel fiber grating strain sensors for civil structures which fulfill all the objectives and advantages sought therefore. Many changes, modifications, variations and applications of the subject invention will become apparent to those skilled in the art after consideration of the specification and accompanying drawings. All such changes, modifications, alterations and other uses and applications which do not depart from the spirit and scope of the invention are deemed to be covered by the invention which is limited only by the claims that follow:

1. A fiber grating strain sensor mounted into a beam including:
a fiber grating strain sensor attached to a beam with its principal longitudinal axis aligned approximately to the axial direction of maximum sensitivity of the beam.

2. A fiber grating strain sensor mounted into a beam as recited in claim 1 where said beam is a composite beam.

3. A fiber grating strain sensor mounted into a beam as recited in claim 2 where said composite beam is attached to angled brackets.

4. A fiber grating strain sensor mounted into a beam as recited in claim 3 where said angle brackets include a fiber feed through.

5. A fiber grating strain sensor mounted in a beam as recited in claim 2 where said angle brackets are encased in a protective housing.

6. A fiber grating strain sensor mounted in a beam as recited in claim 1 where said beam is a metal bar.

7. A fiber grating strain sensor mounted in a beam as recited in claim 6 where a portion of said metal bar has an area of reduced metal;
whereby axial sensitivity is maximized and bending sensitivity is minimized.

8. A fiber grating strain sensor mounted in a beam as recited in claim 7 where said area of reduced metal has a diamond shape.

9. A fiber grating strain sensor mounted in a beam as recited in claim 7 where said area of reduced metal has a rectangular shape.

10. A fiber grating strain sensor mounted in a beam as recited in claim 7 where said area of reduced metal has said fiber grating strain sensor mounted in tension around it.

11. A fiber grating strain sensor mounted in a beam as recited in claim 10 where ends of said metal bar are attached to angled brackets.

12. A fiber grating strain sensor mounted in a beam as recited in claim 11 where said angle brackets have a fiber feed through.

13. A fiber grating strain sensor mounted in a beam as recited in claim 11 where said angle brackets are encased in a protective housing.

14. An environmentally rugged fiber grating strain sensor including:
a bar;
a fiber grating strain sensor placed under tension and attached to the bar near its center;
and attachment points for the bar.

15. A fiber grating strain sensor capable of axial and shear strain measurements consisting of:
a flat rectangular plate;
said flat rectangular plate having at least two regions with material removed from an area near the edge and center of at least two sides of said rectangular plate;
each of said regions having a fiber grating strain sensor place across it under tension.

16. A fiber grating strain sensor capable of axial and shear strain measurements as recited in claim 15 further including:
said flat rectangular plate having material removed from four regions near the center and edge of all four sides;
each of said four regions having a fiber grating strain sensor placed in tension on each side of the region.

17. A fiber grating strain sensor capable of axial and shear strain measurements as recited in claim 16 further including:
said fiber grating strain sensor being place in tension by adhesive bonds on each end of said fiber grating strain sensor.
